(19) United States
(12) Patent Application Publication
(10) Pub. No.: US 2015/0345672 A1
(43) Pub. Date: Dec. 3, 2015

(54) THREAD CLAMPING COUPLER DEVICE

(71) Applicant: Ronald A. Smith, Los Gatos, CA (US)

(72) Inventor: Ronald A. Smith, Los Gatos, CA (US)

(21) Appl. No.: 14/392,045

(22) PCT Filed: Nov. 13, 2013
(86) PCT No.: PCT/US13/00256

§ 371 Date: May 11, 2015

Related U.S. Application Data
(60) Provisional application No. 61/796,548, filed on Nov. 14, 2012.

(51) Int. Cl. F16L 15/08; F16L 15/04

(52) U.S. Cl. CPC F16L 15/08; F16L 15/04

(57) ABSTRACT

A hose coupler is described capable of quick connection and disconnection with only a small amount of rotation required to achieve a fluid-tight seal. A plurality of threaded segments are arranged about a central axis of the coupler into a segment set. Such segments comprise a flexible, elastic material that is capable bending towards or away from the central axis under an applied force but returns to their normal as-manufactured shape upon removal of the applied force. Ease of connection and disconnection without the requirement for substantial force to be applied is one of the salient advantages of the coupler described herein.

### CROSS-REFERENCE TO RELATED APPLICATIONS

This application claims priority pursuant to 35 U.S.C. §119 from provisional patent application 61/796,548 filed Nov. 14, 2012. The entire contents of the aforesaid provisional patent application is incorporated herein by reference for all purposes.

### BACKGROUND OF THE INVENTION

1. Field of Invention

The present invention relates to a hose coupler using moveable female thread clamping segments incorporated into the coupler structure, and more particularly to a device capable of attaching to, and releasing from, male threads of a threaded tube with minimal rotation, and most particularly to a coupling device of simple, robust construction requiring few parts capable of easy manufacture and low cost as required for residential and consumer markets.

2. Description of Prior Art

There are many examples of quick-connect couplings or connectors in the garden hose industry for residential use as well as many such devices for coupling other types of fluid-carrying tubes. However, such devices typically have one or more of the following disadvantages.

a) Many such devices require a special component to be mounted on both tube ends that are to be connected, thereby increasing the cost and inconvenience of the coupler. For example, see U.S. Pat. No. 4,477,109. Perhaps more important, this seriously limits the flexibility of the user of the device. For residential use, a hose carrying a first component of such a two-piece coupler must be connected only to a spigot having the complimentary, second, component. In addition, only devices having the first coupler component can be attached to the spigot having the second component. This limits the flexibility of use substantially and/or markedly increases costs to the consumer having to equip all devices with a second component, even if second components are commercially available by themselves, separate from a two-component set. Thus, a need exists in the art for a quick connection that can attach to standard threads.

b) Some devices provide for rapid connection but slow and tedious disconnection. Typically a “jam nut” or ratcheting coupling device can be connected to the threaded end of a tube quickly but require a slow unwinding process, disengagement of a locking pin or similar time consuming process to disconnect the device. For example, see U.S. Pat. Nos. 4,191,406; 6,425,607; 7,472,931. Such a device would be appropriate for applications in which rapid connection is essential but slow disconnection is not a serious disadvantage (e.g. fire hoses). However, for typical residential, commercial and industrial applications it is advantageous for a hose coupling to permit rapid disconnection as well as connection. Thus, a need exists in the art for a quick connection that can both attach and detach quickly to standard threads.

c) Coupling devices may require considerable twisting to complete the connection (e.g. U.S. Pat. No. 5,503,437). This is disadvantageous in that it slows the connect/disconnect process, can be a difficult process for users without sufficient arm, gripping or twisting strength, and/or may cause the hose to which the coupler is attached to twist which may, in turn, disturb the alignment of the two sections to be coupled. Thus, a need exists in the art for a coupling device requiring only modest twisting to effect the connection.

d) Some coupling devices employ the pressure of the fluid in the hose to effect the connection (e.g. U.S. Pat. No. 7,140,645), or provide pins or clips to hold the coupler or components of the in position (e.g. U.S. Pat. Nos. 5,580,099; 5,800,108), or a “stopper member” serving effectively the same function (U.S. Pat. No. 7,857,361). The present inventor submits that a modest amount of twisting to seat the hose firmly against a sealing gasket (typically no more than about one revolution) is advantageous in that it permits the user to impose the desired amount of pressure to complete the seal, advantageously assisted by a torque-enhancing large diameter structure as described in detail elsewhere herein. As gaskets wear, more pressure may be required to effect a fluid-tight seal. Thus, a need exists in the art for a coupling device allowing the user to tailor the pressure of the connection against the sealing gasket, and to do so with only modest twisting.

e) Robust and reliable operation is advantageous in all applications for all users. However, the purchase price of the device is likely to be a particularly important consideration for residential users with garden hoses and the associated equipment. Thus, limiting manufacturing costs allows the vendor of such a coupler to be price-competitive while earning a fair return and providing a high quality device. Some devices require special materials to be used, certain to increase costs. For example, U.S. Pat. No. 4,045,055 calls for “.a sealing means . . . sufficiently flexible to permit expansion [of lip member 22] during operation, while at the same time possessing sufficient resilience to retain its basic shape throughout long periods of intensive use.” (Col. 4, L. 8-12). Thus, a need exists in the art for a coupling device designed to be manufactured at low cost while achieving excellent performance.

Cronley has described several one-component quick-connecting couplers including the following: U.S. Pat. Nos. 5,503,437; 5,788,289; 6,786,516; 7,140,645: US Patent Application Publications: 2004/0000788; 2004/0130144; 2004/0164547. However, these devices may use hydraulic pressure to provide the final seal and/or use a “compressible-sleeve member” that is compressed radially inward during the functioning of the device, quite distinct from a sealing gasket conventionally used between the two hose components to be joined. Sealing by hydraulic pressure has drawbacks as noted above. A “compressible-sleeve member” provides an additional component to complicate manufacture and, hence, is likely increase the complexity and cost of the device as well as be subject to wear and possible degradation during use.

Thus, a need exists in the art for a hose coupler capable of connecting and disconnecting easily and quickly with standard hose threads and only requiring a minimal rotation (typically clockwise) to seal (couple) to the hose or faucet. Embodiments of the device described herein meet these and other needs as discussed in detail.

### SUMMARY OF THE INVENTION

Accordingly and advantageously, some embodiments of the thread clamping coupler device (TCCD) disclosed herein include a plurality of threaded segments having inward-facing threads thereon, arranged circumferentially around a central axis joined into a segment set, wherein the segment set can move axially along the direction of the central axis in both directions as well as rotate both clockwise and counterclockwise about the central axis as a single unit. The threads on the segments are capable of engaging with the threads of a hose and forming a fluid-tight seal with the TCCD upon rotation of the segment set.

Each of the segments in the segment set is advantageously made of a flexible, elastic material capable of bending towards or away from the TCCD central axis under the influence of an applied force but returning to its normal position when the applied force is removed. Among numerous possible metals, plastics or other materials suited for use as segments, glass filled polyester is found to be advantageous.

The structure and composition of the segments, threads and the segment set (among other structural features described in detail below) permit rapid connection and disconnection of the TCCD with only modest rotational motion.

These and other features and advantages of various embodiments of the present invention will be understood upon consideration of the following detailed description of the invention and the accompanying drawings.

### BRIEF DESCRIPTION OF THE DRAWINGS

To facilitate understanding, identical reference numerals have been used, where possible, to designate identical elements that are common to the figures. It should be noted here that some of the drawings depict internal and/or external threads. The threads illustrated are for explanation purposes and may not always show a true spiral because of imprecision of the CAD software used to generate the drawings. However, the thread profile is accurate. The embodiments described herein have a customary helical structure associated with the particular thread.

The drawings herein are schematic, not necessarily to scale and the relative dimensions of various elements in the drawings are not to scale.

The devices and techniques of the present invention can readily be understood by considering the following detailed description in conjunction with the accompanying drawings, in which:

FIG. 1 is a top perspective view of a typical TCCD.

FIG. 2 is a perspective view of a typical TCCD with a typical hose nipple.

FIG. 3 is a bottom perspective view of a typical TCCD.

FIG. 4 is an exploded view of a typical TCCD in which the combination of inner core 6a and outer core 6b is denoted by 6.

FIG. 5 is a top plan view of a typical TCCD.

FIG. 6 is a side cross sectional view of a typical TCCD and hose nipple.

FIG. 7 is a side cross sectional′view of a typical TCCD with a hose nipple.

FIG. 8 is a side cross sectional view of a typical TCCD.

FIG. 9 is a perspective view of a one eighth slice of a typical TCCD.

FIG. 10 is a perspective view of a one eighth slice of a typical TCCD.

FIG. 11 is a top perspective view of a partial segment set sliced.

FIG. 12 is a bottom perspective view of a partial segment set slice

FIG. 13 is a bottom perspective of a typical TCCD.

FIG. 14 is bottom perspective view of a TCCD and hose nipple as in FIG. 2 with the addition of alignment marks 13, 50 and index band 48.

FIG. 15 is a top perspective view of the outer core.

FIG. 16 is a top perspective view of the inner core.

FIG. 17 is a top plan view of a typical TCCD.

FIG. 18 is a top perspective view of an assembled inner core and outer core and a one-eighth slice of a segment set.

### DETAILED DESCRIPTION

After considering the following description, those skilled in the art will clearly realize that the teachings of the invention can be readily utilized in the fabrication and use of connectors for joining threaded ends of hoses or other fluid-carrying structures.

Embodiments of the present invention relate to the connection and disconnection of fluid-carrying structures in a rapid, effective and reliable fluid-tight manner. The devices described herein have advantages for both connecting and disconnecting fluid-carrying structures. However, for economy of language, we typically refer simply to the connection of such structures understanding thereby that disconnection is understood by the obvious reverse procedure. Separate mention is made of disconnection when such a distinction is intended. Further, we refer to all such fluid-carrying structures as “hoses” not thereby limiting the description to flexible fluid carriers but includes all such fluid-carrying devices.

It is envisioned that a primary use for the thread clamping coupling devices (TCCDs) described herein is for the connection of water hoses in a residential, commercial, industrial, hospital, fire fighting, environmental, hazmat, public safety and/or military setting. However, the devices described herein are not limited to carrying water. Other fluids can also be transported by structures employing the devices described herein, as can slurries, emulsions, powders, mixtures, gasses and essentially any substance transported in pipes, tubes or similar structures. However, for economy of language we refer to the present TCCDs as transporting “water” or “fluid” via “hoses” or “water hoses” not intending to limit the scope to a particular fluid or means of transport.

In addition, for economy of language we describe the present TCCDs as joining a “hose” to another fluid-carrying structure. This is not intended to limit the applications of the present TCCDs to joining a flexible fluid-carrying structure to another structure. The present TCCDs can be used to connect flexible or rigid fluid carrying structures (pipes, faucets, spigots, among others) to other flexible or rigid fluid-carrying structures as apparent to those having ordinary skills in the art. However, since the residential use for connecting water hoses is expected to be a primary use for the present TCCDs, we use “hose” as a brief designation, intending thereby to include the full range of fluid carrying devices.

Some embodiments of the TCCDs described herein relate to devices that screw into the female end of a hose, or could be an integral part of the original hose construction. Thus, the TCCD becomes the female end of the hose, available to facilitate coupling to another fluid-carrying structure. The TCCDs described will engage any other matching male hose threads (hose nipple) with the quick connect/disconnect features of the TCCD with fewer parts, a simplified structure amenable to low cost fabrication, tight sealing with minimal rotation and other advantages as described herein.

Summary of Structure and Operation of Some Embodiments.

In this concise initial description we discuss the behavior of a single segment 22 as TCCD 4 is engaged and disengaged. Multiple segments are actually used in a practical device but the description of a single segment is sufficient for one of ordinary skill in the art to readily understand the structure and operation of a TCCD containing multiple segments.

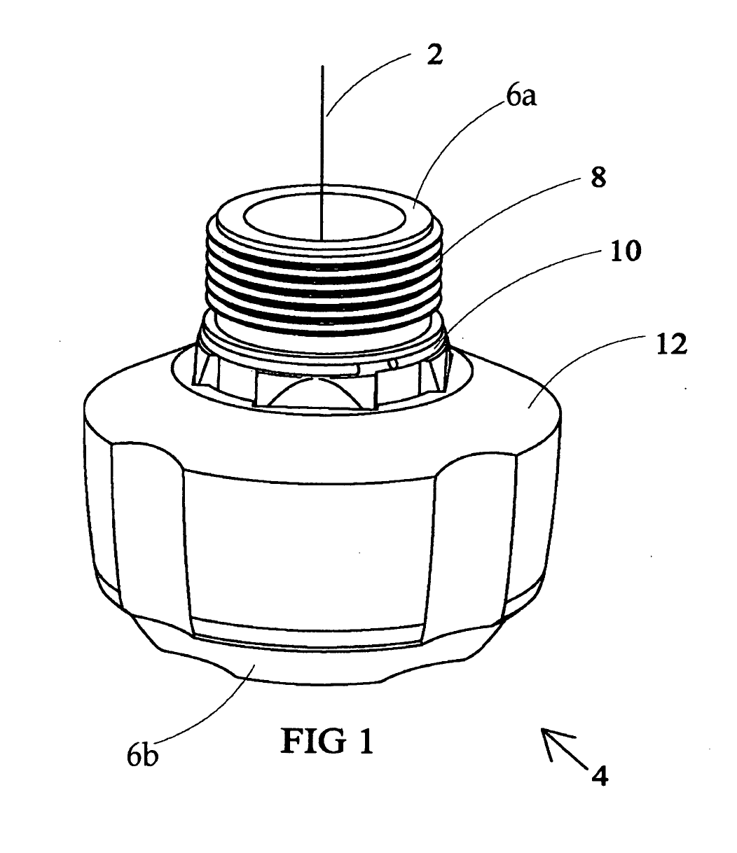

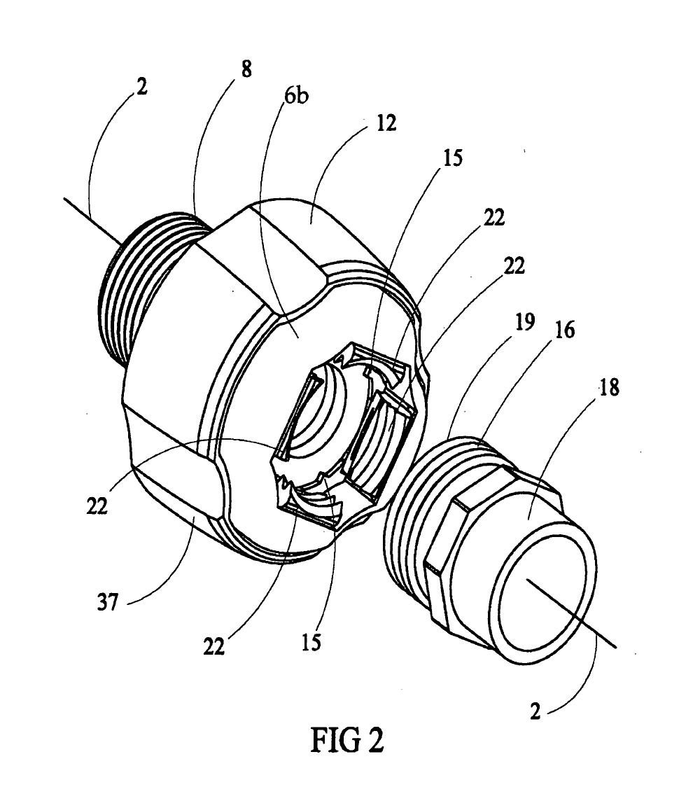

A typical thread clamping coupler device (TCCD) described herein, denoted 4 in FIG. 1, has several important properties and advantages over prior art devices. Among these are the ability quickly to connect or engage the male threads on the end of a hose or any matching male thread. The TCCD 4 also quickly disconnects from the same male thread. To effect the desired and desirable quick engagement, the TCCD 4 is first positioned approximately as depicted in FIG. 2 with respect to the male hose thread (“hose thread”) 16 and hose nipple 18. That is, TCCD 4 facing hose nipple end 19 approximately parallel and aligned along central axis 2.

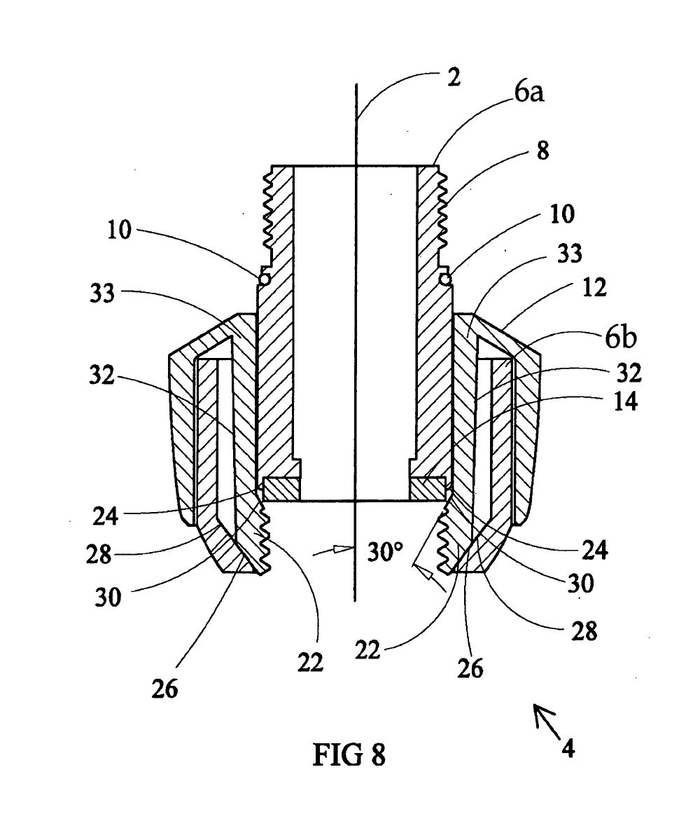

An axial cross sectional view of TCCD 4 in its closed state is given in FIG. 8. Segment beam 32 is integrally joined to the exterior of segment set 12, conveniently formed in a single piece of plastic or other suitable material. Segment threads 20 are located on each segment 22.

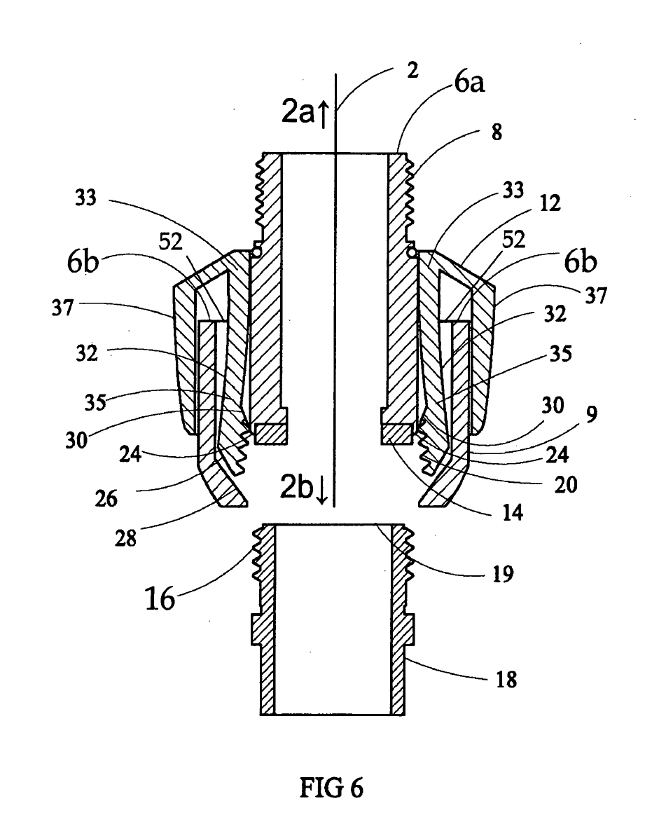

The core of the TCCD 4 has two parts, an inner core 6a and an outer core 6b. Inner core 6a and outer core 6b are integrally joined (typically as snap-together components) or formed as a unified unit, indicated in FIGS. 6-10 by the use of identical cross hatching for 6a and 6b. Segment beam 32 moves vertically (axially in the direction of central axis 2) between the inner and outer core structures and thus has a slot or similar opening through which the connector 52 between the inner and outer cores traverses.

Essentially, the outer core 6b may be used to urge the segments 22 radially inward toward the central axis 2 and the inner core 6a may be used to urge the segments 22 radially outward away from central axis 2. However, in some embodiments the segment beams 32 are fabricated in their inner or closed position as depicted in FIG. 8. The segments are fabricated of a material suitable for bending such that, in the absence of any countervailing forces, segment beams 32 will naturally assume the inward or closed position of FIG. 8. Segments of flexible, elastic material (or simply “bendable material”) fabricated in the outward or open position are discussed elsewhere. With segment set 12 in its lowered position as indicated in FIG. 8, the segments may be further urged toward the central axis 2 by the outer core load bearing surface 28 engaging segment load bearing surface 26. This engagement of the surfaces 28 and 26 is accomplished by CW rotation of TCCD. The axial forces generated by the engagement of surfaces 28 and 26 drive the hose nipple end 19 into gasket 14 to make an adequate seal. Segments 22 may be urged toward the central axis 2 by the outer core 6b, in particular by the core load bearing surface 28 engaging segment load bearing surface 26. However, the flexible, elastic nature of the segment beams will also urge the segments into the closed position. It is advantageous in some embodiments that this bending force provide the primary impetus urging the segments into their closed position.

There are numerous candidate materials for the bendable segments 22 as used herein. Clearly, it is advantageous for all materials in the TCCD that come into contact with the fluid being transported to be substantially impervious to degradation by rust, corrosion, etc. to facilitate a long service life for the TCCD. Many metals meet these criteria for water-carrying TCCDs including aluminum, steel, brass, zinc diecast among others. Many plastics also meet the criteria. Glass filled polyester is one advantageous choice providing an appropriate combination of manufacturability, material properties and cost.

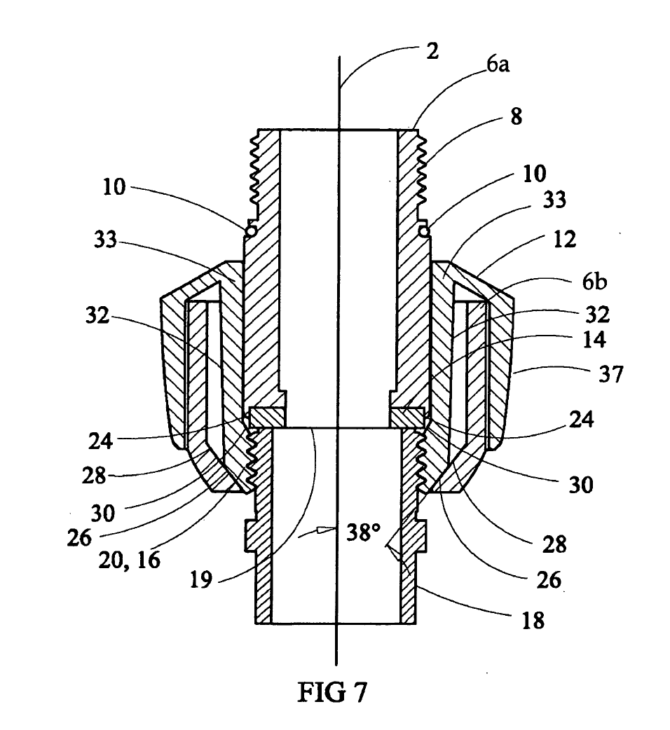

Segment threads 20 in the closed position depicted in FIG. 8 are suited for engaging (threading) with the hose threads 16 or the core threads 8, but are too close together to allow convenient insertion of hose nipple 18 into the TCCD. However, in some embodiments, simple mechanical pressure of hose threads 16 urged against segment threads 20 will be sufficient to cause the segments to be pushed aside and the hose threads can ratchet along segment threads to a bound position substantially as depicted in FIG. 7.

From the initial, as fabricated, position depicted in FIG. 8, segment set 12 is urged upward (“upward” in the sense depicted in FIGS. 6, 7 and 8). This causes segments 22 and threads thereon 20 to move radially away from the central axis 2 into the configuration depicted in cross sectional view in FIG. 6. This urges segment 22 and threads 20 to move radially away from central axis 2 due to contact with the lower edge of inner core 6a with the uppermost thread 22 (or uppermost portion of the threaded region of segment 20, whether or not it is an actual thread), or a combination of these mechanisms.

Once the segment threads 20 have been retracted from central axis 2 to such an extent that the minor diameter of the threads is greater than the major diameter of hose thread 16, the hose nipple end 19 is inserted into the TCCD 4 and stopped against the surface of the sealing gasket 14 (see FIG. 6). When the hose nipple end 19 is thus engaged with the gasket 14, segment set 12 is returned to its original lowered position (as in FIG. 6), causing thereby segment threads 20 to engage with hose threads 16 as depicted in FIG. 7. Upon clockwise (CW) rotation of the TCCD 4, the segments 22 are urged away from gasket 14 as the hose end seals against the gasket surface. The motion of the segment 22 away from the gasket 14 causes the segment load bearing surface 26 to engage outer core surface 28. Engagement of surface 26 with surface 28 drives the segment 22 radially inward against hose nipple threads 16. This action drives the hose nipple toward the gasket 14. The engagement of segment load bearing surface 26 with outer core surface 28 tightens the seal of gasket 14 to hose nipple end 19. Clockwise (CW) rotation of the TCCD with respect to the hose nipple urges the hose nipple toward the TCCD (for customary right-handed threads) and effects a watertight seal. Typically the TCCD 4 needs to be rotated CW by only approximately 180 degrees or less relative to the hose nipple to effect a water tight seal (see FIG. 7). This is a decided advantage over typical prior art female hose connectors since, if one only has to rotate the hose no more than approximately 180 degrees to achieve a sealed connection, the need for a swivel at the end of the hose is eliminated. Once a water tight seal is in effect as described herein, the connection is complete.

Disengaging or disconnecting TCCD 4 from hose nipple 18 requires only modest time and effort. The TCCD 4 is rotated CCW (counter-clockwise) relative to the hose nipple 18 until the hose threads 16 loosen from the segment threads 20. As soon as the threads are slightly loose the segments 22 can be retracted to the open position by moving the segment set 12 in the direction away from the hose nipple 18 thus opening segments 22 and releasing the TCCD 4 from the hose nipple 18, as depicted in FIG. 6.

Further Description

Some embodiments of the TCCDs described herein use threaded female moving segments that facilitate quick connection to a threaded tube (or hose nipple). Upon applying an external CW torque to tighten the TCCD, the TCCD drives the segments into the threaded tube when the TCCD rotates and urges the male threads axially further into the TCCD. This provides locking friction between the segment threads and the tube threads (hose nipple 18).

The structure of threads on threaded tubes may be defined according to profile geometry, diametral pitch, axial pitch and dimension among other characteristics. See for example, Machinery's Handbook, 28^{th} Ed. (Industrial Press, 2008), pp. 1708-2026. The diameter of the tube also affects the geometry of the threads on the tube. For economy of language, we use “thread type”, “thread structure”, “thread geometry” and the like to denote a particular thread on a tube with a particular diameter.

The movable segments of the TCCD typically have different thread structures capable of engaging corresponding thread structures on different types of tubes. That is, each movable segment (or set of segments) of a TCCD will be designed to meet the standards for a particular thread on a particular tube.

Thus, to be concrete in our description, the TCCDs described herein typically have four equally spaced segments. Other configurations and numbers of segments and segment sets are clearly envisioned within the scope of this invention, and a few illustrative examples are also given. Each TCCD is designed to engage a specific male thread. The following are typical thread standards for hoses and other structures:

NH (“National Hose”)—Standard hose coupling threads of full form as produced by cutting or rolling.

NHR (“National Hose (Rolled or Rounded)”)—Standard hose coupling threads for garden hose applications where the design utilizes thin walled material which is formed to the desired thread.

NPSH (“National Pipe Straight Hose”)—Standard straight hose coupling thread series in sizes 0.5 to 4 inches for joining to American National Standard taper pipe threads using a gasket to seal the joint.

American National Fire Hose Connection Screw Thread.

American National and Unified Screw Thread Form (typically referred to as English or inch threads).

American National Standard Metric Screw Thread (typically referred to as Metric threads).

SAE Spark-Plug Screw Threads.

Lamp base and Socket Shell Threads.

Tire Valve Inflation Connection Typically referred to as a Shrader Valve.

FIG. 1 is a top perspective view of a typical TCCD 4.

FIG. 2 is a bottom perspective view of a typical TCCD with four segments 22 in the position they would have when engaging hose thread 16 (or simply the “engaged position”). A typical hose nipple 18 (the male thread end of the hose) is shown separated from the TCCD in a position where engagement between the TCCD and segment threads 20 and hose nipple threads 16 would occur should the TCCD be urged toward hose threads 16 and segment threads 20 moved to a disengaged position as described and depicted elsewhere herein.

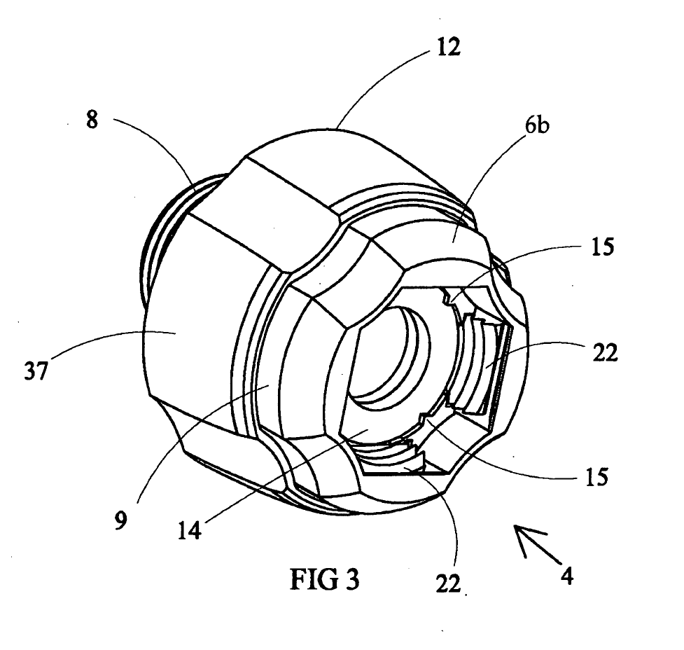

FIG. 3 is a bottom perspective view of TCCD 4. In this view, gasket 14, gasket retention wedges 15 are visible. Segments 22 are shown in the open, retracted or disengaged position (“open,” “retracted,” “disengaged” position refer to the same state of the TCCD and are used herein interchangeably). Since the segments are retracted in FIG. 3, this indicates that segment set 12 is also in a “retracted” position, moved upwards along inner core 6a as depicted in FIG. 6. This is clear since segments 22 and segment 12 are all the same part. Because the segment set 12 is retracted more of outer core 6b is exposed revealing an exposed core 9.

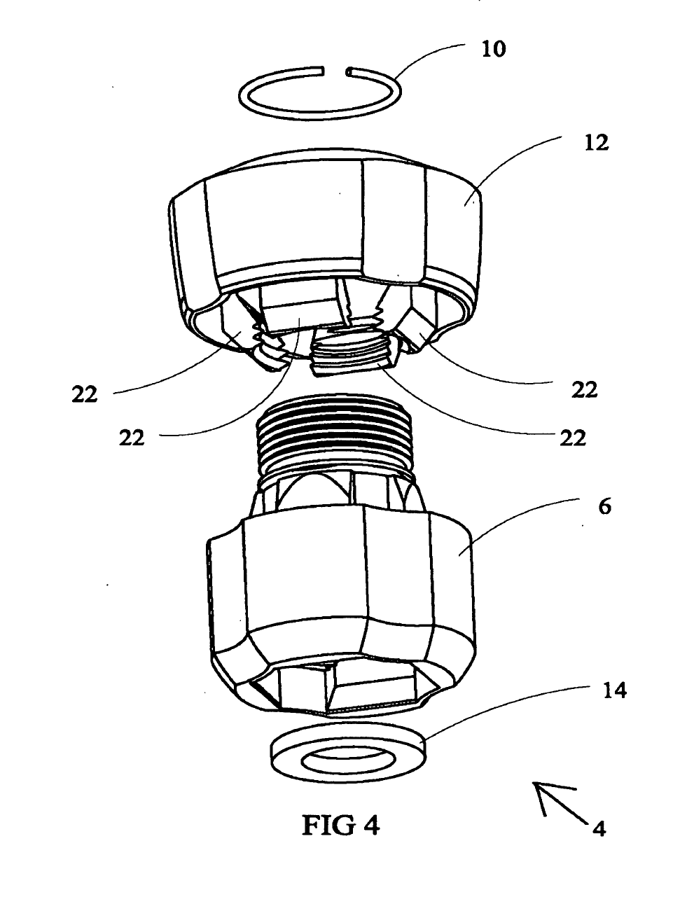

FIG. 4 illustrates a complete TCCD 4 with parts exploded. Comprising TCCD 4 are the retainer snap ring 10 (or “snap ring”), segment set 12, outer core 6b and gasket 14. The segments 22 are shown in the closed position.

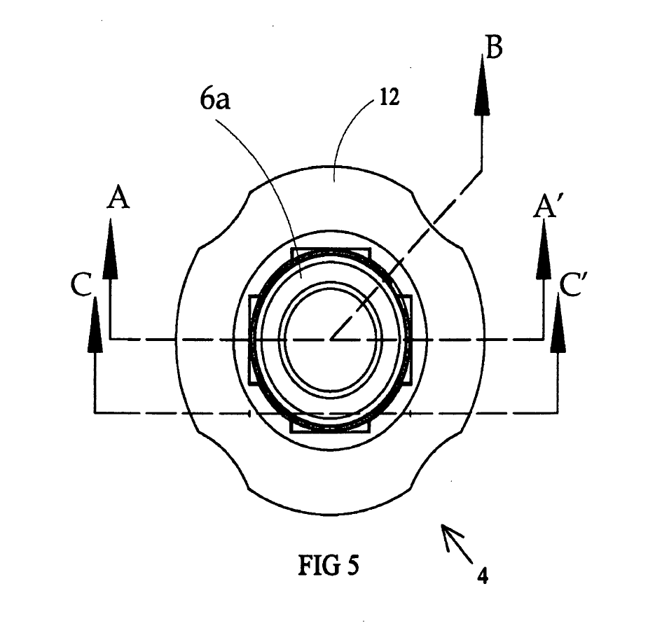

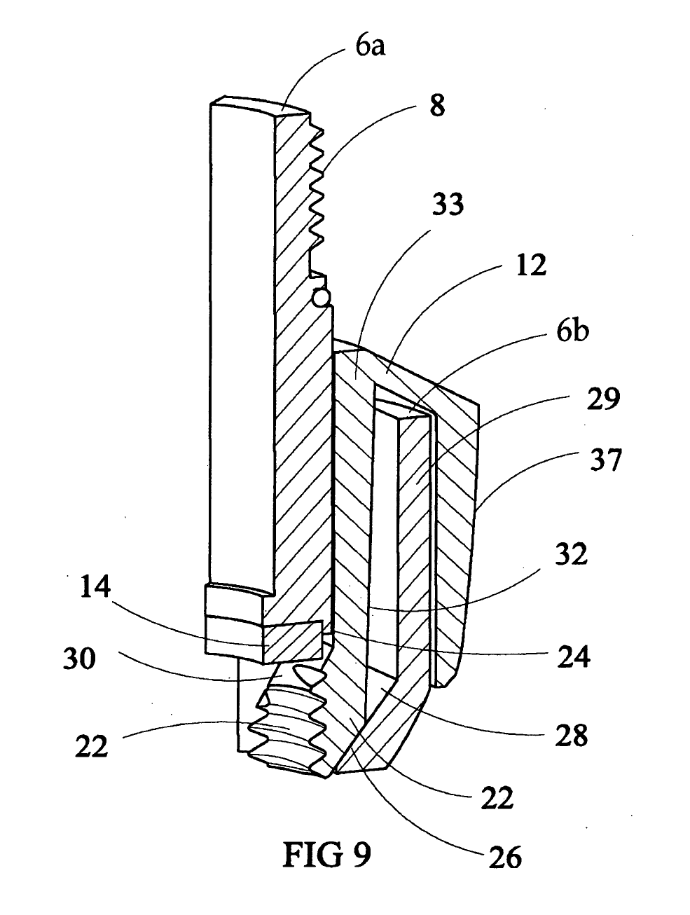

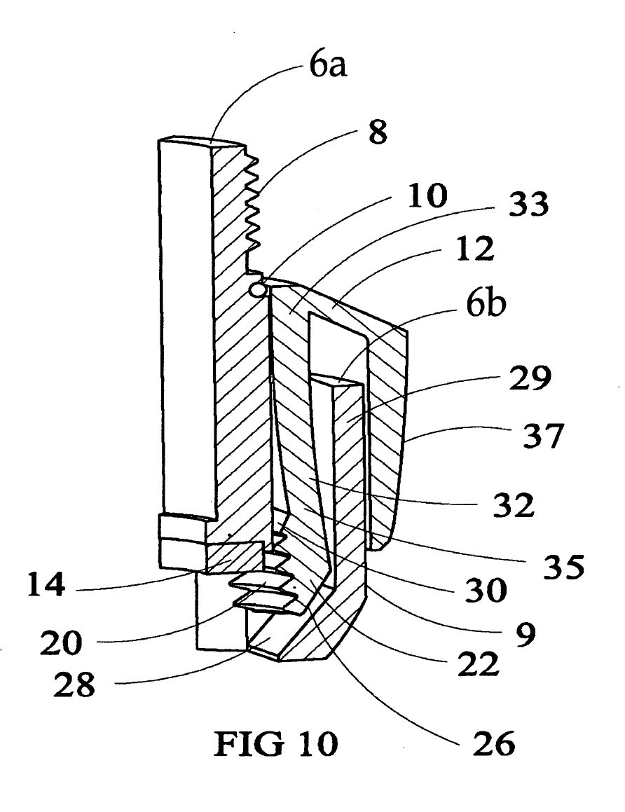

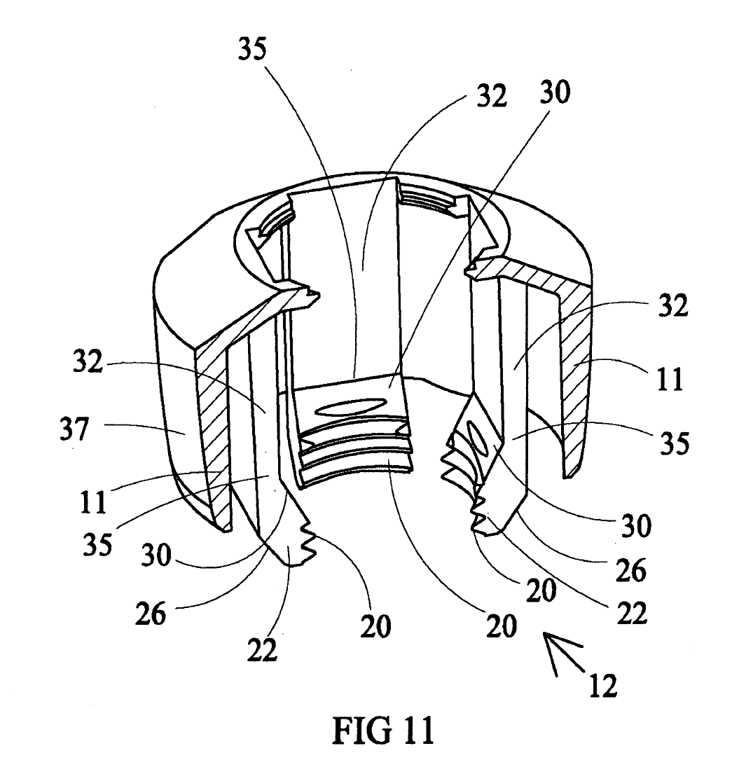

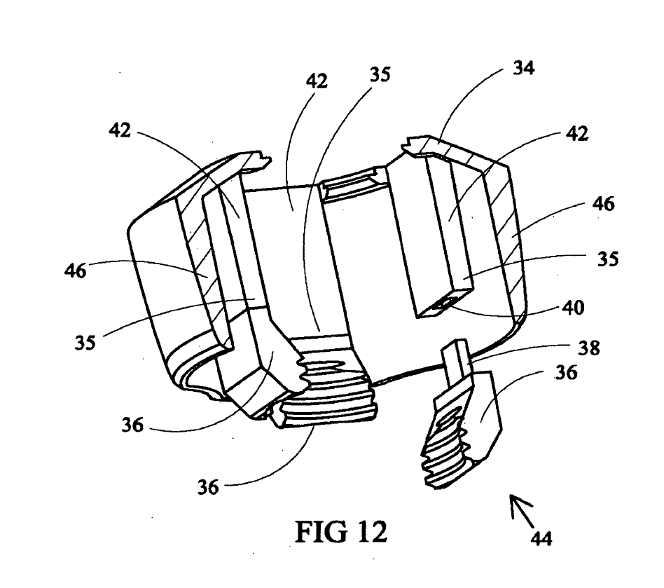

FIG. 5 is a top view of TCCD 4 showing the section lines that define the cross sections shown in figures. Section Line A-A′ (FIG. 6, FIG. 7, FIG. 8), Section Line A′-B (FIG. 9, FIG. 10), Section Line C-C′ (FIG. 11 and FIG. 12).

FIG. 6 is a cross section taken along line A-A′ in FIG. 5. TCCD 4 and hose nipple (“threaded tube”) 18 are shown in cross section. Hose nipple 18 is shown separated from TCCD 4 in a position ready to be inserted into TCCD 4. Segment beam 32 is shown deflected to the open position as a result of segment set 12 moving upward toward core threads 8. The deflection of segment beam 32 is caused when segment ramp 30 engages core cam (or “core cam edge”) 24. Full deflection to the open or retracted position of segments 22 is achieved when segment set 12 reaches the limit of rearward travel toward core threads 8 and away from the TCCD opening that receives hose nipple 18. Clearance is shown between segment load bearing surface 26 and core load bearing surface 28. The free end 35 of segment beam 32 (or “cantilever segment beam”) is shown along with the connected end 33 of cantilever segment beam 32. The outside surface 37 of segment set 12 is shown where the user would typically grasp TCCD 4.

FIG. 7 is a cross section taken along A-A′ in FIG. 5. TCCD 4 and hose nipple 18 are shown in cross section. Hose nipple 18 is shown engaged with TCCD 4. Specifically, segment threads 20 are shown engaged with hose nipple threads 16 (or “hose threads”). Segment beam 32 is shown non-deflected in the closed or engaged position. Also shown is segment load bearing surface 26 engaged with core load bearing surface 28. Both load bearing surfaces 26 and 28 are at an angle of approximately 38 degrees with respect to central axis 2, although a fairly wide range of angles around 38 deg. can also be used. Also shown is hose nipple end 19 engaged with gasket 14. The outside surface 37 of segment set 12 is shown where the user would typically grasp TCCD 4 to apply torque to engage TCCD or disengage TCCD 4 with respect to hose nipple 18.

FIG. 8 is a cross section along A-A′ in FIG. 5 the same as FIG. 7 except that hose nipple 18 is removed to show more clearly segments 22 in the closed position and segment load bearing surface 26 engaged with core load bearing surface 28.

FIG. 9 is a magnified perspective view of a slice of TCCD 4 along section line A′-B of FIG. 5. FIG. 9 is another view of segment 22 in the closed position where segment load bearing surface 26 is engaged with core load bearing surface 28. Also shown is segment ramp 30 disengaged from core cam 24. Segment beam 32 is shown in the non-deflected state. Segment set 12 is in its most forward position or closest to the opening in TCCD 4 that receives hose nipple 18. Segment set 12 is prevented from moving further forward because of core 6 load bearing surface 28 and core wall 29.

FIG. 10 is a magnified perspective view of slice taken of TCCD 4 along section line A′-B of FIG. 5. FIG. 10 is another view of segment 22 in the open position where segment load bearing surface 26 is clear of core load bearing surface 28. Segment beam 32 is shown in the deflected state. Segment set 12 is in its most rearward (upward, retracted or elevated) position or furthest from the opening in TCCD 4 that receives hose nipple 18. Segment set 12 is prevented from moving further rearward by snap ring 10. In some embodiments, snap ring 10 is replaced with a pin located at substantially the same location and suited for preventing further rearward movement of segment set 12. Either snap ring, pin or other retaining device as obvious to those having ordinary skills in the art can be used to retain or restrain segment set 12 from moving too far along central axis 2 away from threaded tube 18.

FIG. 11 is a magnified, cut-away perspective view of a slice of segment set 12 taken along section line C-C′ of FIG. 5. This FIG. 11 more clearly shows the segment beams 32, segments 22 and segment threads 20 as a single part. Only three of the four segment beams 32 are shown because of the slice removing part of the outer wall 11 of segment set 12 whereon the fourth segment beam would appear. Although a different number of segments can be used (2, 3 or more than 4), the use of four segments appears to be advantageous in terms of achieving a good balance of function and economics.

Some or all of the segments in segment set 12 can be made to be replaceable. Plastic segment beams offer advantages in the economics of fabrication but might not offer the durability of a steel or another material. One example of this is presented in FIG. 12 which is a perspective view of a slice of segment set 44 taken along section line C-C′ of FIG. 5. FIG. 11 more clearly shows the segment beams 32 and replaceable segments 36. Only three of the four segment beams 42 are shown because of the slice removing part of the outer wall 46 of segment set 44. Segment set 44 has replaceable segments 36 with post 38 extending from the top of replaceable segment 36. The free end 35 of segment beams 42 have a receptacle 40 for receiving post 38. Functionally, segment set 44 is identical to segment set 12 except that replaceable segments 36 may be constructed of different material than segment beams 42. Other than the post 38 extending from the top of replaceable segment 36, the geometry of replaceable segment 36 is essentially the same as that of segment 22. If a segment set has four segments then all four segments must have a different geometry since the segments must have a phased thread to match the thread phase of the hose thread 16. Also the replaceable segments 36 must be assembled in the correct sequence to match the hose thread 16.

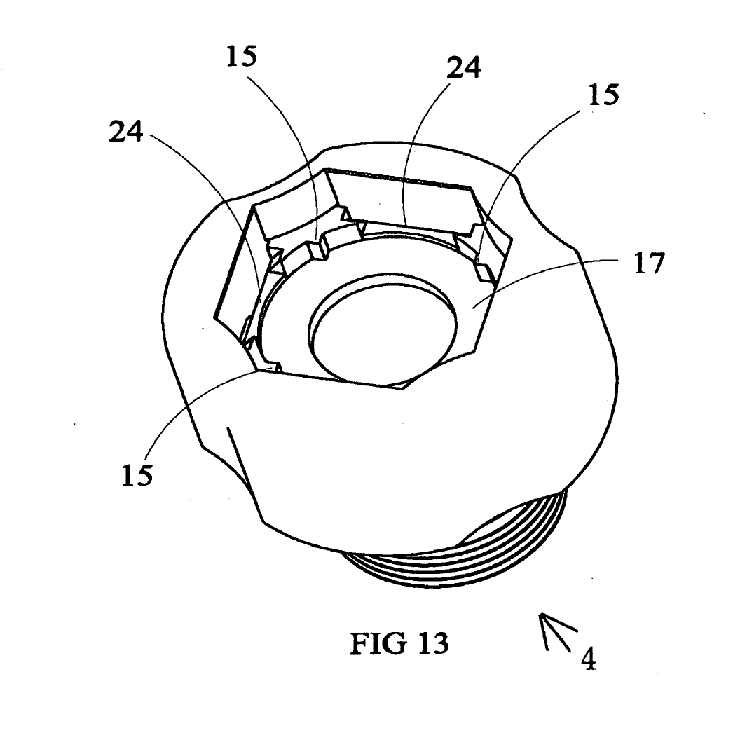

FIG. 13 is a bottom perspective view of TCCD 4. showing core cam 24. Core cam 24 engages segment ramp 30 (shown in FIG. 6 through FIG. 11) when segment set 12 or segment set 44 is transitioning from the closed or engaged position to the open or retracted position. Upon engagement of core cam 24 with segment ramp 30 segment beam 32 is deflected, thereby stressing the segment beam material and thus storing energy and providing the self closing force that urges the segments 22 to the closed position.

Also shown in FIG. 13 are gasket retention wedges 15. This embodiment has four wedges 15 equally spaced 90 degrees apart on core gasket surface 17, only three of which are visible in FIG. 13.

There are two fundamental positions of segments 22 relative to the core structure 6a, 6b during normal operation of TCCDs. There is an open position (shown in FIG. 3, FIG. 6 and FIG. 10) and there is a closed position (shown in FIG. 1, FIG. 2, FIG. 4, FIG. 7, FIG. 8, FIG. 9, FIG. 11 and FIG. 12). The open position refers to segments 22 being moved radially outward, axially upward along central axis 2 and rotated approximately eight degrees while attached to the end of the segment beam 32 as segment beam 32 is deflected outward radially from central axis 2. An eight degree deflection is an approximate value for the deflection of conventional segment beam material. Other materials would lead to other values for this deflection angle.

The segment beams in the current TCCD devices are flexible and elastic (“bendable”), capable of bending to accommodate the motion of the segments toward and away from the central axis, but returning to the closed position of FIG. 8 when no forces are present urging them into the open position away from the central axis. This bendable property of segment beams 32 serves the function of, and replaces, several components present in typical prior art devices, and provides the basis for some of the simplicity, ease of use and low cost of the present devices. Similar advantages accrue for segments manufactured in the open position as discussed below.

Segment beam 32 is a cantilever beam in which one end 33 (see FIG. 6, FIG. 7, FIG. 8 and FIG. 9) is attached (or integrally fabricated with) to the remaining segment set structure including the outside surface 37 and opposite free end 35 is attached to segment 22 (or integrally fabricated therewith). Free end 35 and segment 22 are free to deflect if forces are applied in the appropriate direction. One of the functions of segment beam 32 is to act as a spring. One definition of a spring is, “an elastic body or device that recovers its original shape when released after being distorted” and this is the sense in which this particular property of the segment beam 32 is used herein.

The “closed position” for segments 22 denotes the case in which they are in the position close to central axis 2 as if engaging with hose thread 16. It is convenient in some embodiments for the segments 22 to be manufactured in this position so that, when displaced away from central axis 2, natural forces arise in the material of segments 22 urging them back towards the central axis. After the initial manufacture segment set 12 and segments 22 are in an unassembled condition with respect to inner and outer core 6a and 6b. This closed position is physically the same as the engaged position when TCCD 4 is attached to hose nipple 18. To reach the closed or engaged position when attaching TCCD 4 to hoses thread 16, segment beam 32 must be deflected to the open position so segment threads 20 pass over hose threads 16 during hose nipple 18 insertion into TCCD 4. If segment threads 20 are engaged with hose threads 16 then segment 22 is referred to as being in the engaged position. When segments 22 are in the engaged position with respect to hose thread 16 segments 22 are also in the closed position. However, the segments can be in the closed position and not be engaged with hose nipple 18 as for example when segment set 12 is initially manufactured and as shown in FIG. 4, FIG. 8, FIG. 9 and FIG. 11.

To move the segments from the closed position to the open position, the user applies a force sliding segment set 12 away from TCCD 4 opening and toward core threads 8, that is from the configuration of FIG. 7 to that of FIG. 6. Segments 22 will move easily until segment ramp 30 engages core cam 24 (see FIG. 8 and FIG. 9). Continued axial travel will cause core cam 24 to ride up segment ramp 30 and deflect segment beam 32 (see FIG. 6 and FIG. 10). Segment beam 32 must deflect away from core 6 as the segments continue movement toward core threads 8. This segment beam 32 deflection stresses the beam material internally. The force to urge segment set 12 axially toward core threads 8 increases as segment beams 32 continue to deflect until segments 22 are in the open position shown in FIG. 6 and FIG. 10.

If the force provided by the user is removed (that is, axial sliding force on segment set 12), the segments will attempt to move axially in the opposite direction away from core threads 8. This self-closing force is provided by the mechanical energy stored in deflected segment beams 32 attempting to return to the non-deflected state or a material state where no excess mechanical energy is stored.

Deflected segment ramp 30 is provides a force directed against core cam 24. Ramp 30 is at an angle of approximately 30 degrees relative to central axis 2 when the segment beams 32 are in the unstressed or non-deflected condition. Upon deflection segment beams 32 bend away from inner core 6a causing segments 22 that are attached to segment beam 32 to rotate approximately eight degrees. The deflected and stressed beams provide a self-closing function with respect to the segment set 12. Segment set 12 will move to the closed position or will engage threads 16 of hose nipple 18 if present.

The angle of the segment ramp 30 relates to the force required to cause segment set 12 to move away from the TCCD opening as the segment beam 32 is deflected as ramp 30 moves up the core cam edge 24. As the ramp angle increases relative to the central axis 2 (the angle being measured at in the as-manufactured position and not after segment deflection) so does the force to urge the segment set 12 to move away from the TCCD opening increase. Conversely the force increases as provided by the deflected segments 22 that urges the segments 22 along with the entire segment set 12 to move toward the TCCD opening and to the closed position as ramp 30 angle increases relative to central axis 2.

Segment set 12 is comprised of all segments 22 and segment beams 32, typically manufactured as a single part. The segment threads 20 are phased with respect to each segment 22. Segment threads 20 are equivalent to a tube with an internal thread identical to segment threads 20. If one removed a 20 degree pie slice four times equally spaced about the threaded tube perimeter what would remain is equivalent to the segments threads 20 in the segment set 12. As manufactured, the segment threads 20 are in the closed position and have a minor diameter less than or equal to the hose thread 16 minor diameter. Therefore when the segment beam 32 is not deflected the segment thread 20 will engage the hose thread 16.

In another embodiment of the present invention it is possible to manufacture the segment set 12 so the segments are initially in the open position. Therefore, such segments will tend to remain in the open position. In order to cause the segments to deflect inward toward and reach the closed or engaged position, the segment set 12 must be urged forward, opposite the as-manufactured segments in the closed position. As the segments move forward segment load bearing surface 26 will engage core load bearing surface 28 (see FIG. 6). The engagement of surfaces 26 and 28 will cause the segment beams 32 to deflect inward and have opposite curvature of deflection as currently shown in FIG. 6. The segments will reach the closed position and/or engage the hose threads 16 on nipple 18. Rotating the engaged segment threads 20 of TCCD CW with respect to the nipple 18 will lock the TCCD to nipple 18 and secure a water tight seal as nipple end 19 is urged toward and sealed against gasket 14.

Disengagement is accomplished through a CCW rotation and loosening of TCCD 4 relative to nipple 18. In this “reverse” configuration, segments 22 will self-open rather than self-close. Nipple 18 will be easily released from TCCD 4.

Referring to the as-manufactured closed embodiment described herein and examining segments 22, after hose nipple 18 is inserted into TCCD 4 and nipple end 19 engages gasket 14, TCCD 4 must be rotated CW to effect a watertight seal. Upon CW rotation engaged segments 22 urge hose nipple 18 toward gasket 14 which in turn is supported by core gasket surface 17. A reaction force urges segments 22 in the opposite direction until the segments load bearing surface 26 is tight against the corresponding core load bearing surface 28. As the seal is tightened, segments 22 are compressed between hose thread 16 and core load bearing surface 28. When in compression the segment threads 20 are able to transfer much higher loads than standard threads in a nut that are stressed in pure shear when loaded. This unique configuration allows the TCCD 4 to survive relatively high external torques to be applied and not have segment threads fail even though the segment thread 20 material may have substantially less ultimate strength than the material of hose thread 16. Since the segments 22 are typically manufactured as a single piece the segment threads 20 will engage or disengage at the same time with the hose threads 16.

The method of retaining gasket 14 by the retention wedges 15 is shown in FIG. 2, FIG. 3 and FIG. 13.

The points of the wedges are conveniently on a circle concentric with central axis 2. The circle has a diameter less than the outside diameter of gasket 14. The interference between the wedge points and the gasket outer diameter compresses the gasket material and provides retention forces for the gasket. During operation of the TCCD 4 when hose nipple 18 is engaged, the gasket 14 is trapped between core gasket surface 17 and hose nipple end 19. When no hose nipple is attached to TCCD 4 the forces on the gasket 14 provided by wedges 15 retain the gasket in place. The forces provided by the wedges 15 are caused to be sufficient to retain the gasket 14, but replacement of the gasket is still very easy to accomplish merely by pulling the gasket out and pushing a replacement in between the wedges 15 and against core gasket surface 17.

FIG. 11 depicts another embodiment using segment set 44 with replaceable segments 36. Segments 36 have post 38 extending from the top surface of segment 36. Post 38 is received by receptacle 40 in the bottom surface of segment beam 42. Once segment 36 is firmly attached to segment beam 42 segment set 44 will operate the same as segment set 12 in our first embodiment. An advantage of replaceable segments is that the material of the segments can be changed typically to employ more durable material than that of the segment beams 44. Any or all of the segments in this embodiment could be replaceable or not as desired. All four of segments 36 must use a phased thread and must be assembled in the same sequence as the first embodiment to have the equivalent function.

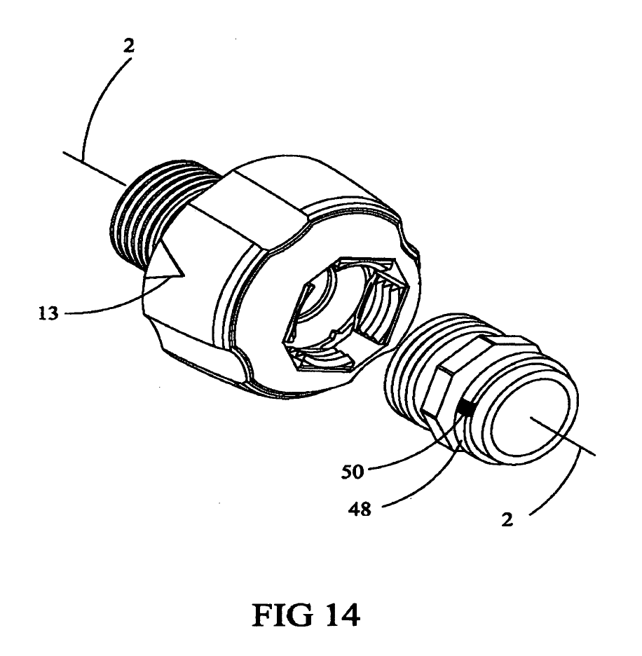

Another embodiment is depicted in FIG. 14 which is a TCCD as described elsewhere herein with the addition of alignment marks, typically an arrow or alignment arrow 13 on the TCCD and index mark 50 on index band 48. Arrow 13 is added to the TCCD in an arbitrary position around the circumference of the segment set. The hose nipple is firmly attached to the TCCD and twisted firmly in position against gasket 14 as described elsewhere herein. The segment set is then rotated in a disconnecting fashion (typically CCW) until the segment threads disengage from the hose threads. At this position, index band 48 is attached around threaded tube with the index mark 50 aligned arrow 13 (or rotated to this position if the band is pre-attached). In this configuration arrow 13 in alignment with index mark 50 denotes the optimal position for inserting the threaded tube into the TCCD, facilitating rapid attachment and detachment in the optimal orientation for reduced twisting.

It should be noted that the circumferential position of alignment arrow 13 with respect to the phase of the segment threads should be the same for all TCCDs so that all TCCDs have the same radial position for advantageous thread engagement and disengagement for any specific hose nipple 18. For example, a residential user of a TCCD typically acquires a TCCD with alignment arrow 13 thereon, along with an index band 13 having an index mark 50 thereon. This user then mounts the index band 48 onto a spigot or other male-threaded hose and aligns the index mark 50 with the alignment arrow 13 as described above. The user naturally wants the same index and alignment marks to provide proper alignment when different TCCDs are joined to the same spigot. This will occur only if alignment mark 13 has the same radial position with respect to segment thread phases on all TCCDs.

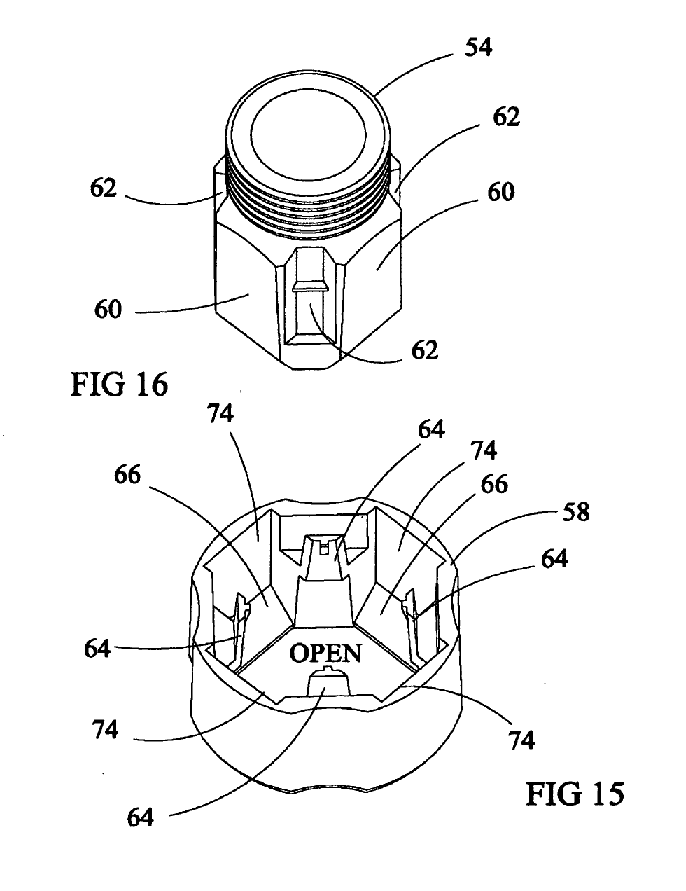

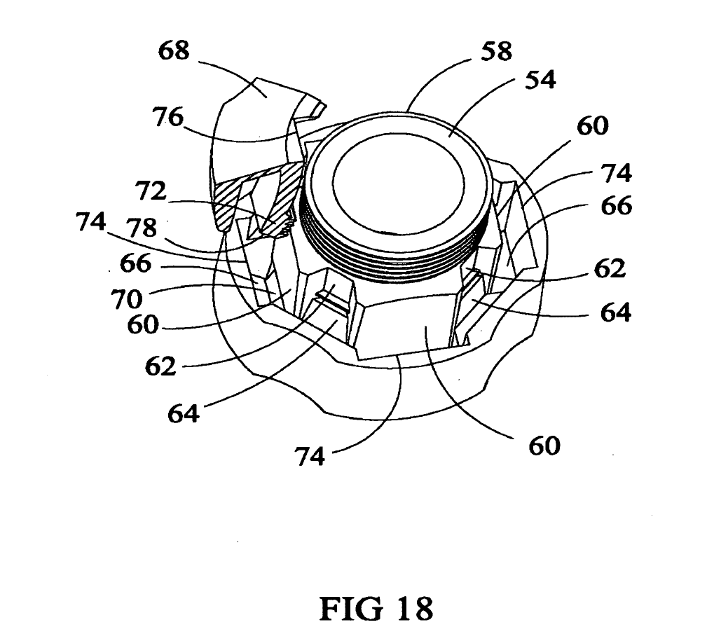

FIG. 15 is a top perspective view of outer core 56 showing features that lock to the inner core 54. The four inner core locking tabs 64 lock into inner core channels 62 (see FIG. 16). Torque is transmitted from the inner core channels 62 to the outer core tabs 64 and then to the segments when outer core load bearing surface 66 engages segment load bearing surface 78 shown in FIG. 18. Also shown in FIG. 15 are four segment slots 74 that receive the four segments during assembly of the segments into the inner core/outer core assembly shown in FIG. 18.

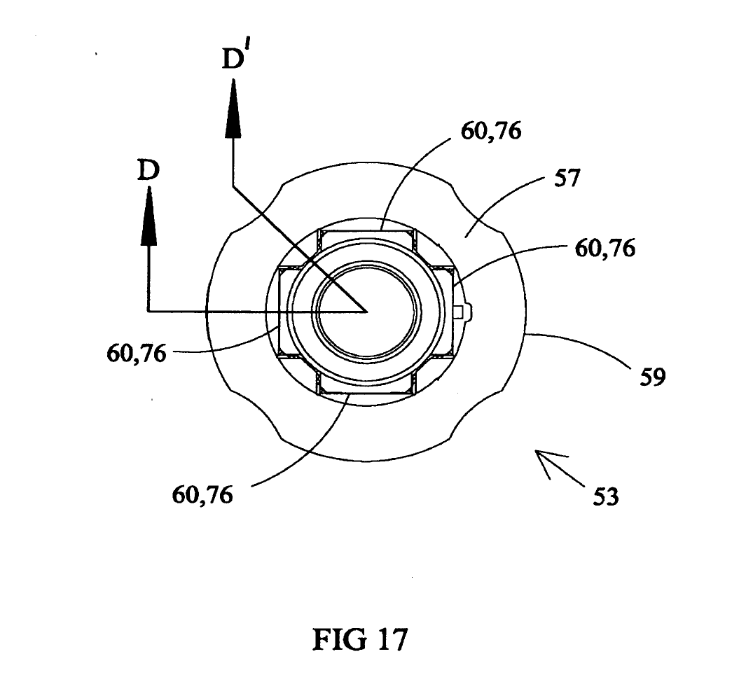

FIG. 16 is a top perspective view of the inner core 54 showing features that guide the inner core 54 axially with respect to the segment set (one eighth slice shown in FIG. 18) and transmit torque with the segment set and with the outer core 56. The four inner core walls 60 transmit torque from the segment set top opening 76 (shown in FIG. 17 and FIG. 18). The top opening 76 also provides axial guidance when engaging inner core wall 60. Segment set top opening 76 also transmits torque to inner core 54 through engagement with inner core wall 60. Inner core channel 62 locks with outer core tab 64 providing a fixed core assembly that provides guidance and torque to the segment set 68. Torque is passed from inner core 54 to outer core 56 through the channel 62 and tab 64 locking interface. Also shown is core load bearing surface 66 (in other embodiments surface 66 is referred to as surface 28 as in FIG. 8) that transmits torque to segments through segment load bearing surface 78 (referred to as surface 26 in FIG. 8).

It is important to note that inner core load bearing surface 66 (and 28) and segment load bearing surface 78 (and 26) are flat surfaces. It is the torque transmitted to the segments that causes the segments to engage the hose nipple threads and to rotate about the hose nipple to cause the TCCD to seal to the hose nipple.

FIG. 17 is a top plan view of TCCD 53. The user transmits torque to the TCCD by grasping segment set outer surface 59 and applying a twisting motion. The torque generated by the user is transmitted to the inner core 54 through the engagement of segment set top opening 76 and inner core wall 60. Also depicted is the segment set one eighth slice section (shown in FIG. 18) defined by D-D′.

FIG. 18 is a top perspective view of an assembled inner core and outer core and a one eighth slice of a segment set. Shown is an inner core 54 attached to an outer core 56 to form a core assembly 58. The outer core tab 64 is shown locked into inner core channel 62. FIG. 18 also shows a segment set with deflected segment beam 72 being installed over inner core 54. The engagement of wall 60 with segment set beam 72 is what deflects the segment beam to its maximum open position. Upon further axial travel down the segment beam 72 will be guided by outer core segment slot 74 until the segment beam reaches the opening 70. Upon reaching the opening 70 the segment beam 70 will return to its as fabricated closed configuration (shown in FIGS. 8,9 and 10).

Other embodiments can readily be configured to engage lamp socket threads to provide quick coupling and decoupling for light bulbs or other electrical devices using lamp socket threads. One of the segments would necessarily be reconfigured to provide electrical conduction to the outer thread structure and another connection would be required in the center where the current gasket 14 resides. The inner hole that now carries fluid (water) would be used to house electrical conductors such as wires.

Yet other embodiments could readily be configured to engage tire valves for bicycles, autos, trucks or any vehicle or device requiring inflatable tires. Such a configuration would provide quick coupling and decoupling for tire inflation devices.

Although various embodiments which incorporate the teachings of the present invention have been shown and described in detail herein, those skilled in the art can readily devise many other varied embodiments that still incorporate these teachings.

1. A thread clamping coupler for connecting to a male threaded end of a fluid-carrying hose comprising:
a) a plurality of threaded segments arranged circumferentially around a central axis, fixedly mounted into a segment set wherein said segment set is capable of moving axially along the direction of said central axis as a single unit and rotating about said central axis as a single unit; and,
a-1) wherein each of said threaded segments has inwardly directed threads on a first lower end thereof suited for engaging a threaded hose nipple so as to draw said threaded hose nipple into said thread clamping coupler against a gasket so as to provide a fluid-tight seal with said gasket when said segment set is rotated about said central axis; and,
a-2) wherein each of said threaded segments is joined into said segment set at a second opposite end thereof; and,
a-3) wherein the material comprising each of said plurality of threaded segments is bendable such that the threaded first end of said threaded segment can be urged radially toward or away from said central axis by an applied force, pivoting on said second end of said threaded segment, and said threaded segment returns to its original shape when said applied force is removed; and,
b) a central core substantially coaxial with said central axis and integral attached thereto a core load bearing surface for each of said threaded segments arranges so as to apply a force urging said first threaded end of said threaded segment in a radial direction when the segment set is moved in an axial direction along said central axis; and,
c) a retainer surrounding said core so as to prevent said segment set from motion along said central axis in a direction opposite from said hose nipple threads.

2. A thread clamping coupler as in claim 1 wherein said threaded segments are fabricated in their inner, closed position and return to this position in the absence of applied forces.

3. A thread clamping coupler as in claim 1 wherein said threaded segments are fabricated in their outer, open position and return to this position in the absence of applied forces.

4. A thread clamping coupler as in claim 1 wherein said threaded segments are capable of removal and replacement within said segment set.

5. A thread clamping coupler as in claim 1 further comprising:
in combination, a hose nipple to which said thread clamping coupler attaches, wherein said thread clamping coupler has an alignment marker on an outside surface thereof, said hose nipple has an index ring with an index marker thereon wherein said alignment marker and said index marker, when aligned, denote the preferred orientation for joining said hose nipple with said thread clamping coupler.

6. A thread clamping coupler as in claim 1 wherein said threaded segments are glass filled polyester.
